(19) United States
(12) Patent Application Publication
(10) Pub. No.: US 2005/0169347 A1
(43) Pub. Date: Aug. 4, 2005

(54) Portable infrared temperature sensor

(76) Inventor: Tony Kuo, Tao-Yuan (TW)

Correspondence Address: SUPREME PATENT SERVICES, POST OFFICE BOX 2339, SARATOGA, CA, 95070, US

(21) Appl. No.: 11/038,917

(22) Filed: Jan. 19, 2005

(30) Foreign Application Priority Data
Jan. 30, 2004 (TW) 093201342

(51) Int. Cl. G01K 1/00

(52) U.S. Cl. 374/121; 374/208

(57) ABSTRACT

A portable infrared temperature sensor is provided, which is able to prevent from electromagnetic and electrostatic interferences, and also the after effect of ambient temperature changes, so as to produce accurate temperature measurement. The portable temperature sensor includes a core module, a cylindrical body, a shielding layer and a battery unit, where the shielding layer includes a collar ring, which wraps around one end of the core module to prevent outside interferences with the sensor reception, and a non-conductive mould, which covers the circuit board in the core module. The core module includes a circuit board on which an IR detector, an output unit, and a switch mechanism are installed. The portable design makes the infrared temperature sensor convenient for carrying around and easy to use for a wide range of applications.

### BACKGROUND OF THE INVENTION

1. Field of the Invention

The present invention relates to a portable infrared temperature sensor, and in particular to a non-contact infrared thermometer that is able to prevent the electromagnetic and electrostatic interferences during the temperature measurement, as well as the after effect of ambient temperature changes in order to produce accurate temperature values.

2. The Related Art

Conventional thermometers have many different types: mercury-based, electronic, or non-contact infrared. The mercury thermometer shows slow response with its mercury column. The electronic thermometer employs a thermal detector for heat conduction through the target surface, and the temperature variation within a time interval is taken to estimate the temperature value when the thermal balance is reached. The non-contact infrared thermometer is to detect infrared emission, and the total energy received is averaged, so the temperature value is produced much faster than the two previously mentioned.

However, the infrared thermometer requires more stringent conditions for the temperature measurement, such as ambient temperature, electromagnetic interference and electrostatics all will affect the accuracy of the temperature measurement.

In a plastic casing, the conventional infrared thermometer is susceptible to electromagnetic and electrostatic effects. Since the infrared thermometers have to make use of ambient temperature compensation technology, the heat radiation in the surrounding environment should be quickly reflected to the thermal mass which is the metal part surrounding the thermopile sensor, but the plastic material hinders the heat conduction through the casing responsively. Therefore, it is understandable that the temperature value produced by the conventional infrared thermometer is not very accurate, especially when the ambient temperature is subjected to wide fluctuation.

### SUMMARY OF THE INVENTION

The primary objective of the present invention is to provide a portable infrared temperature sensor that is able to prevent the electromagnetic and electrostatic interferences during the temperature measurement, and also the after effect of ambient temperature changes, in order to produce accurate temperature measurement.

The secondary objective of the invention is to produce a portable design that makes the infrared temperature sensor convenient for carrying around and easy to use for a wide range of applications.

To this end, the portable infrared temperature sensor includes a cylindrical body, a core module, a shielding layer, and a battery unit, wherein the module includes a circuit board on which an IR detector, an output unit and a switch mechanism are installed, and the shielding layer has a collar ring, which wraps around one end of the IR detector to prevent outside interferences with the sensor reception, and a non-conductive mould, over which the embedded circuit board is placed.

In accordance with the present invention, the output unit can be an LCD panel used to visually display the temperature value, or a buzzer used to issue warning signals when the temperature is over/under certain pre-selected levels, or a wireless communication component used to transmit the temperature values to another location where the data can be saved or analyzed by a computer or PDA.

The present invention is characterized in that a dot/spot light can be installed at the tip of the cylindrical body and on the same axial as the IR detector, which is used to guide the portable temperature sensor pointing at the target spot with greater accuracy.

In accordance with the present invention, the cylindrical body also has first and second openings, on opposite ends of the cylindrical body, which are respectively fitted with first and second screw plugs.

In accordance with the present invention, another accessory item is a cap that can be inserted over the top of the portable temperature sensor, where the external surface of the cap is attached with a clip for clipping the portable temperature sensor onto the clothes or working uniform of the user.

In accordance with the present invention, an optional header socket can be coupled on top of the portable temperature sensor. Through the cone-shaped socket, the field of view of the portable temperature sensor can be appropriately set for effective optical resolution, which is usually denoted by d/s ratio representing the working distance from the target surface over the diameter of the target spot. Using the header socket, the working distance between the target surface and the temperature sensor can be fixed, as well as the field of view of the temperature sensor.

In accordance with the present invention, an optional pen can be attached to the bottom end of the portable temperature sensor. Other accessory items include an LED component, a digital recorder, a contact-type thermometer, a distance measuring device, or a barometer, thus making the portable temperature sensor to be a multi-purpose tool.

When measuring the body temperature, the portable temperature sensor is held up with one hand to allow the axial of the temperature sensor to be directed toward the object, and infrared signals from the target area are collected by the IR detector on the front end of the temperature sensor, transferred to analog signal by thermopile and then passed to the embedded circuit board, through which a temperature value is produced, and is displayed by the output unit through the display window in split seconds.

Since the IR detector and the circuit board are protected by the collar ring and the non-conductive mould respectively, the core module is physically isolated from the metal cylindrical body, so that static electricity and electromagnetic cannot penetrate to the core module to interfere with the sensor reception.

In accordance with the present invention, the metal housing of the portable temperature sensor exhibits good heat conductivity, so that ambient temperature can be quickly reflected onto the thermal mass inside the core module in order to produce the necessary ambient temperature compensation for calculating the temperature value. Even when the ambient temperature is subjected to wide temperature fluctuation, the portable temperature sensor is still able to produce accurate temperature readings.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is a perspective view of the present invention;

FIG. 2 is an exploded view of the portable infrared temperature sensor in accordance with the present invention;

FIG. 3 is a sectional view of the infrared temperature sensor;

FIG. 4 is a schematic diagram of a second embodiment of the invention;

FIG. 5 is a schematic diagram of a third embodiment of the invention;

FIG. 6 is a schematic diagram of a fourth embodiment of the invention; and

FIG. 7 is a schematic diagram of a fifth embodiment of the invention.

### DETAILED DESCRIPTION OF THE PREFERRED EMBODIMENT

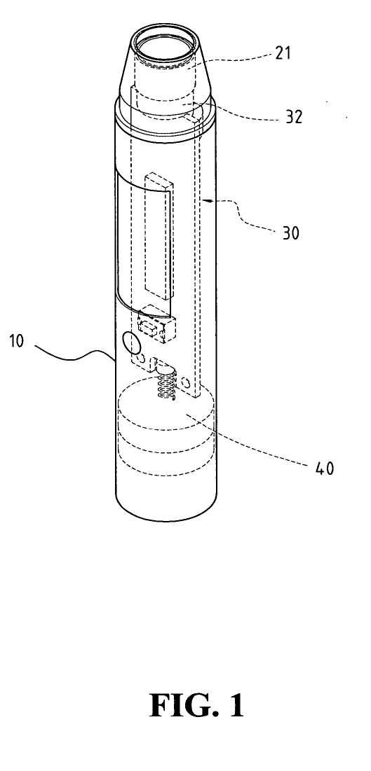

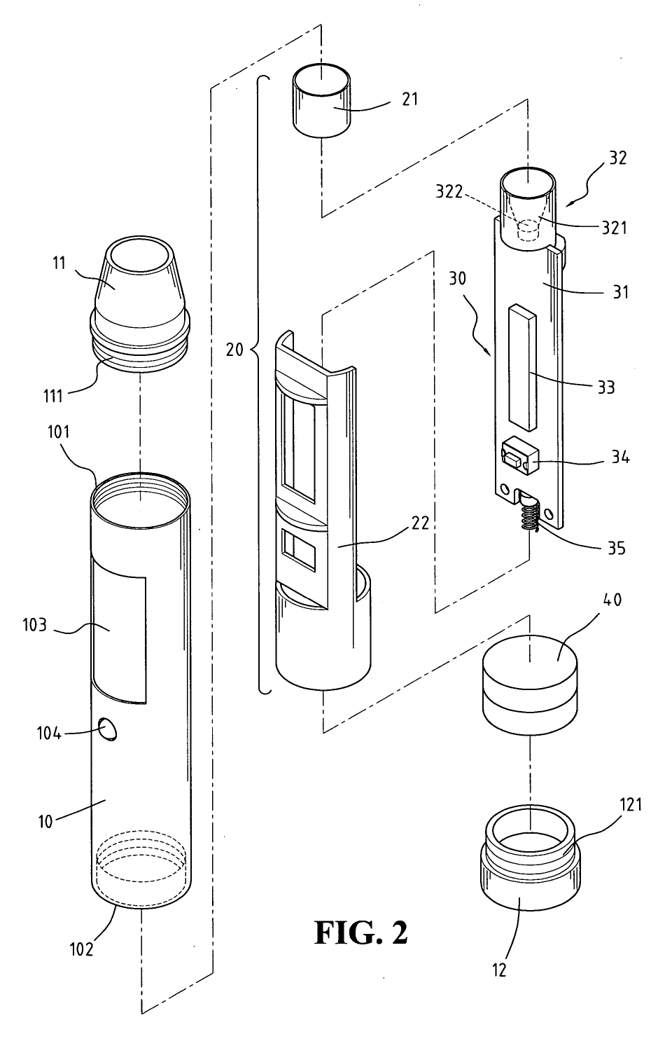

Referring to FIGS. 1 and 2, the portable infrared temperature sensor comprises a cylindrical body 10, a shielding layer 20, a core module 30, and a battery unit 40, where the core module 30 has an IR detector 32, which includes a thermal mass 321 and thermopile 322, is mounted coaxially on one end of the core module 30, through which radiation signals are collected from the target area of an object, transferred to analog signal by thermopile and then passed to the embedded circuit board, through which a temperature value is produced, and is displayed by the output unit through the display window in split seconds.

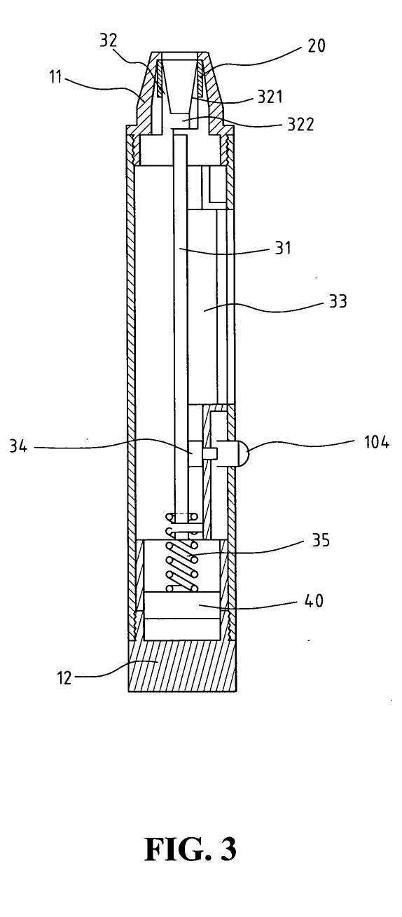

Referring to FIGS. 2 and 3, the core module 30 of the portable temperature sensor includes a circuit board 31, over which an IR detector 32, an output unit 33, and a switch mechanism 34 are installed. The shielding layer 20 includes a collar ring 21, which is fitted over one end of the IR detector 32, and a non-conductive mould 22, over which the circuit board 31 is fixed inside the cylindrical body 10. The collar ring 21 and the non-conductive mould 22 can be formed with rubber or other non-conductive material. Since the collar ring 21 and the mould 22 are both non-conductive, the temperature control circuit in the core module 30 is isolated from the cylindrical body 10, which is metallic, thus electrostatics and electromagnetic interferences are shielded off, which could otherwise impair the sensor reception.

Alternatively, the cylindrical body can be made with plastic material, and coated with a metallic layer on the surface. The metallic coating exhibits the same characteristics as a metallic housing, so as to attain the shielding effect against electromagnetic interference.

The cylindrical body 10 using metallic materials exhibits good heat conduction characteristics. Even if the ambient temperature is subjected to wide fluctuation, the portable temperature sensor is still able to obtain accurate temperature measurement.

The collar ring 21 disposed around the IR detector 32 can be made with heat conducting material, so that the heat radiation of the object can be rapidly transmitted to the IR detector 21 to improve the thermal balance during the temperature measurement.

The hand contact area of the cylindrical body 10 can be made with heat insulation material, or else the collar ring 21 can be made with heat insulation material to prevent the heat irradiating from the user hand which holds the portable temperature sensor from affecting the temperature measurement.

When the core module 30 is inserted into the cylindrical body 10 during assembling of the portable temperature sensor, the switch mechanism 34 is fitted underneath the button 104, and a spring 35 is placed under the circuit board 31 to make an electrical connection between the circuit board 31 and the battery unit 40, so that the battery power is fed to the circuit board 31 and other components in the core module 30.

The battery unit can be a button type lithium, cadmium, or mercury battery. After the button 104 is depressed, the switch mechanism 34 activates the IR detector 32, so that IR signals are received and passed to the circuit board 31 to produce temperature value through the output unit 33.

The output unit 33 can be an LCD display, a buzzer or a wireless communication component. If the output unit 33 is a LCD display, temperature value is displayed through a display window on the cylindrical body 10.

The portable temperature sensor can be equipped with a buzzer. If the temperature value reaches over or drops under pre-selected warning levels, the buzzer is enabled to warn the user of possible abnormal situations.

Also, the portable temperature sensor can be equipped with a wireless communication component to transmit the temperature values to a remote computer or other digital device for simultaneous recording of the temperature data.

The cylindrical body 10 is formed with first and second openings 101, 102, on opposite ends of the cylindrical body 10, where the first opening 101 is fitted with first screw plug 11 and the second opening 102 is fitted with a second screw plug 12.

The bottom part of the first screw plug 11 has outward threads 111, and the second screw plug 12 also has outward threads 121, which are to be fitted with corresponding inward threads on the walls of the first opening 101 and second opening 102, so that the first screw plug 11 and second screw plug 12 can be tightly coupled with the cylindrical body 10.

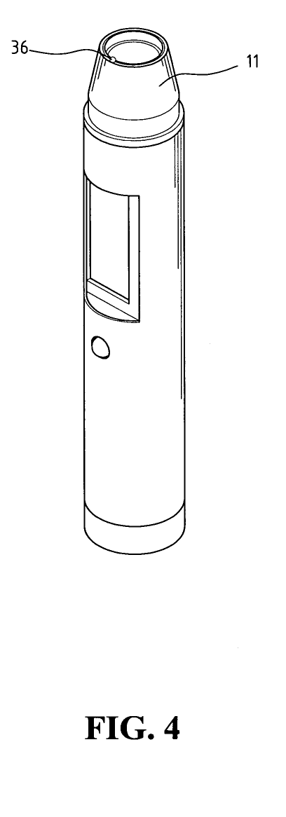

In the second embodiment of the invention as shown in FIG. 4, the tip of the first screw plug 11 has a spot light 36, coaxially mounted with the IR detector 32 in the core module 30, which is used to guide the portable temperature sensor pointing at the target area with greater accuracy. When the button 104 is depressed, the light 36 is enabled to point the portable temperature sensor toward the target area. The spot light 36 can have one or multiple bulbs and with different sizes for different applications. The spot light 36 can be projected onto the target area in the form of a single dot, a line, a round shape, or a triangular shape, suitable for identification of the target area. The spot light 36 is electrically connected to the circuit board 31 to receive the necessary electric power.

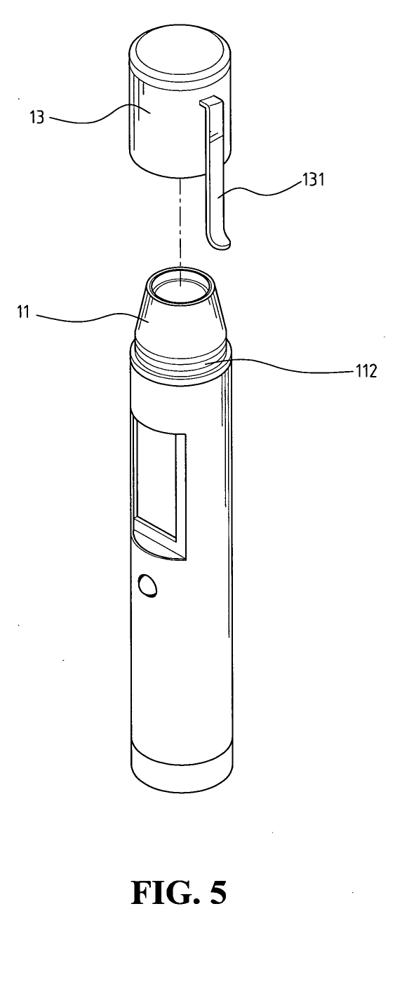

In the third embodiment of the invention as shown in FIG. 5, a cap 13 is attached over the first screw plug 11 and fitted into grooves 112 on the bottom ring of the screw plug 11, so that the IR detector 32 can be protected from the outside environment. The cap 13 also has complementary grooves on the inner ring to better secure the cap 13 on the cylindrical body 10. The cap 13 has a clip 131 on the external surface that allows the user to clip the portable temperature sensor onto the working uniform.

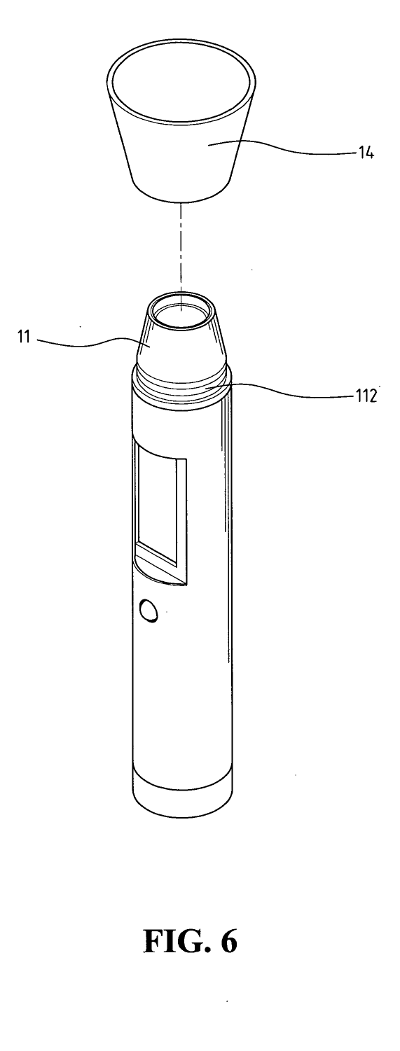

In the fourth embodiment of the invention as shown in FIG. 6, the portable temperature sensor can be accompanied by a header socket 14, which is attached on top of the first screw plug 11 and secured by grooves 112 on the bottom ring of the first screw plug 11. The header socket 14 is used to set the field of view of the temperature sensor for effective optical resolution. The field of view is usually denoted by d/s ratio, which represents the working distance over the diameter of the target area. The portable temperature sensor can thus be positioned at a fixed working distance and focused on a fixed target area with the aid of the header socket 14 The header socket 14 is shaped like an inverted cone with the narrow end attached onto the first screw plug 11, and the open end of the header socket 14 is placed perpendicularly over the target surface when measuring the temperature of the object to obtain reliable IR signals from the target surface.

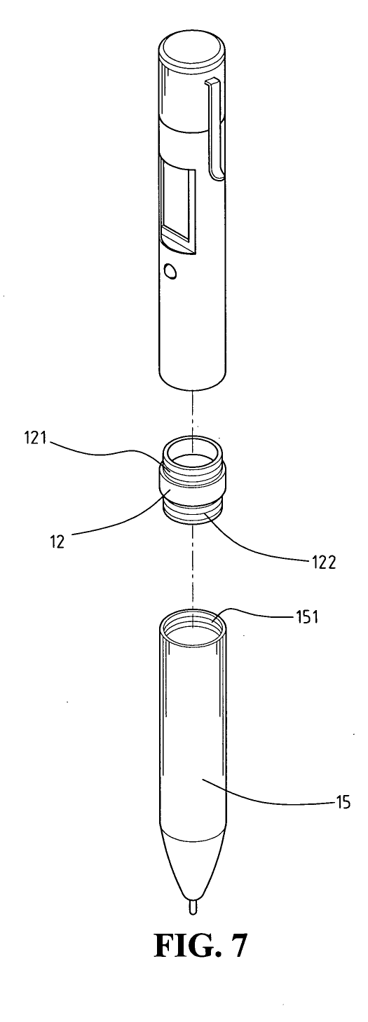

In the fifth embodiment of the invention as shown in FIG. 7, the second screw plug 12 has grooves 122 on the bottom ring, on the opposite side of the threads 121, for coupling with other functional units. Each functional unit shall have complementary grooves 151 for coupling with the bottom end of the portable temperature sensor. These optional functional units may be a pen 15, as shown in FIG. 7, an LED lamp, or a digital recorder for recording of the temperature data. The optional functional unit may also be a contact-type thermometer for measuring the internal temperature underneath the target area and for double checking the reliability of the portable temperature sensor. Further, the portable temperature sensor may be connected with a distance measuring device for confirming the working distance in a temperature measurement. Finally, the portable temperature sensor may be attached with a barometer for measuring the atmospheric pressure around the target area, so that the pressure and temperature data can be simultaneously obtained and analyzed to create meaningful charts and diagrams.

Although the present invention has been described with reference to the preferred embodiments thereof, it is apparent to those skilled in the art that a variety of modifications and changes may be made without departing from the scope of the present invention which is intended to be defined by the appended claims.

1. A portable infrared temperature sensor, comprising:
a cylindrical body which is metallic;
a core module having IR detector;
a shielding layer wrapping around the core module against interferences from outside sources, and isolating the core module from the cylindrical body; and
a battery unit.

2. The portable infrared temperature sensor as claimed in claim 1, wherein the core module has a circuit board, on which an IR detector, an output unit, and a switch mechanism are installed.

3. The portable infrared temperature sensor as claimed in claim 1, wherein the shielding layer is made of non-conductive material.

4. The portable infrared temperature sensor as claimed in claim 1, wherein the shielding layer is composed of a collar ring which is fitted over the IR detector, and a non-conductive mould over which the circuit board is placed.

5. The portable infrared temperature sensor as claimed in claim 4 wherein the collar ring is made with non heat insulation materials.

6. The portable infrared temperature sensor as claimed in claim 4, wherein the collar ring is made with heat insulation materials.

7. The portable infrared temperature sensor as claimed in claim 1, wherein the output unit is a LCD display, so that temperature values are visually output through a display window of the cylindrical body.

8. The portable infrared temperature sensor as claimed in claim 1, wherein the output unit is a buzzer.

9. The portable infrared temperature sensor as claimed in claim 1, wherein the output unit is a wireless communication component.

10. The portable infrared temperature sensor as claimed in claim 1, wherein a spot light is installed on one end of the cylindrical body for directing the temperature sensor to point at the target area.

11. The portable infrared temperature sensor as claimed in claim 1, wherein the cylindrical body further includes a first opening into which a first screw plug is fitted.

12. The portable infrared temperature sensor as claimed in claim 11, wherein the first opening and the first screw plug have matching threads on inner and outer rings respectively for mutual coupling.

13. The portable infrared temperature sensor as claimed in claim 11, wherein the first screw plug and the first opening shall be tightly coupled.

14. The portable infrared temperature sensor as claimed in claim 11, wherein the first screw plug is further attached with a cap over the top to protect the IR detector from dust and moisture.

15. The portable infrared temperature sensor as claimed in claim 14, wherein the cap has a clip on the external surface to allow the temperature sensor to be clipped onto the working uniform of the user.

16. The portable infrared temperature sensor as claimed in claim 11, wherein the first screw plug is attached with a header socket over the top.

17. The portable infrared temperature sensor as claimed in claim 1, wherein the cylindrical body has a second opening into which a second screw plug is fitted.

18. The portable infrared temperature sensor as claimed in claim 17, wherein the second opening and the second screw plug have matching threads on inner and outer rings respectively for mutual coupling.

19. The portable infrared temperature sensor as claimed in claim 17, wherein the second opening and the second screw plug shall be tightly coupled.

20. The portable infrared temperature sensor as claimed in claim 17, wherein the second screw plug has grooves on the bottom ring for attaching other functional devices.

21. The portable infrared temperature sensor as claimed in claim 20, wherein the bottom of the second screw plug is attached with a pen.

22. The portable infrared temperature sensor as claimed in claim 20, wherein the bottom of the second screw plug is attached with a LED lamp.

23. The portable infrared temperature sensor as claimed in claim 20, wherein the bottom of the second screw plug is attached with a digital recorder.

24. The portable infrared temperature sensor as claimed in claim 20, wherein the bottom of the second screw plug is attached with a contact-type thermometer.

25. The portable infrared temperature sensor as claimed in claim 20, wherein the bottom of the second screw plug is attached with a distance measuring device.

26. The portable infrared temperature sensor as claimed in claim 20, wherein the bottom of the second screw plug is attached with a barometer.
